(19) United States
(12) Patent Application Publication
(10) Pub. No.: US 2004/0189180 A1
(43) Pub. Date: Sep. 30, 2004

(54) Color selection electrode assembly and cathode ray tube

(76) Inventor: Kouji Shingai, Tokyo (JP)

Correspondence Address: BIRCH STEWART KOLASCH & BIRCH, PO BOX 747, FALLS CHURCH, VA, 22040-0747, US

(21) Appl. No.: 10/743,145

(22) Filed: Dec. 23, 2003

(30) Foreign Application Priority Data
Mar. 27, 2003 (JP) 2003-087660

(51) Int. Cl. H01J 29/46

(52) U.S. Cl. 313/456; 313/243

(57) ABSTRACT

A color selection assembly includes a color selection electrode and a frame for supporting the color selection electrode. The frame applies a tension to the color selection electrode in the direction of V-axis. The color selection electrode includes a perforated area having a plurality of openings for the passage of electron beams and non-perforated areas formed on both sides of the perforated area in the direction of H-axis. The non-perforated area has a center portion and end portions disposed on both sides of the center portion in the direction of V-axis. The center portion has a width wider than the widths of the end portions.

### BACKGROUND OF THE INVENTION

The present invention relates to a color cathode ray tube employed in a television sets, computer monitors and the like, and to a color selection electrode assembly used in the color cathode ray tube.

A color cathode ray tube has a rectangular color selection electrode having a perforated area in which a plurality of slits are formed for the passage of electron beams. The color selection electrode is suspended by a frame in such a manner that a tension is applied to the color selection electrode in the direction along the short sides of the color selection electrode, i.e., in the direction parallel to the longitudinal direction of the slits.

The color selection electrode is welded to a frame while the frame is pressed and resiliently deformed. After the welding, the pressing of the frame is stopped, so that the frame resiliently returns to its original shape and thereby applies the tension to the color selection electrode.

The tension applied to the color selection electrode has a distribution in the longitudinal direction of the color selection electrode. The tension is the largest in the vicinity of each end of the color selection electrode in the longitudinal direction. Thus, the slits closest to the ends of the perforated area (referred to herein as end slits) may easily deform, and therefore the widths of the end slits may easily vary. In order to reduce the variation of the widths of the end slits, a color selection electrode has been proposed in which extra slits are formed outside the perforated area (see, for example, references 1 and 2 of the patent references listed below).

Patent References

1. Japanese Patent No. 3194290 (pp. 2-3, FIG. 1)

2. Japanese Patent No. 3158297 (pp. 2-3, FIG. 2)

In the above-described color selection electrode, the extra slits have narrow widths and are disposed proximately to the respective end slits, and therefore it is difficult to cancel the influence of the distribution of the tension on the widths of the end slits. As a result, the widths of the end slits can not be kept constant.

Further, the shapes of the end slits are visually inspected at the final inspection process, and therefore there may be an oversight by the inspector because of lack of skill or the like. In such a case, when the color selection electrode is used as a mask in an exposure process for forming a phosphor screen, it is difficult to precisely perform exposure. As a result, the edge of the effective screen area can not be correctly formed.

An object of the present invention is to provide a color cathode ray tube and a color selection electrode assembly that can suppress the variation of the widths of the end slits of the color selection electrode.

### SUMMARY OF THE INVENTION

A color cathode ray tube according to the present invention includes a vacuum envelope including a faceplate having a phosphor screen inside thereof, and a substantially funnel-shaped portion connected to the faceplate. A rectangular color selection electrode is provided in the faceplate in such a manner that the color selection electrode faces the phosphor screen. First and second directions are defined on the color selection electrode. A frame is fixed to the faceplate. The frame supports the color selection electrode in such a manner that the frame applies a tension to the color selection electrode in the second direction. The color selection electrode includes a perforated area having a plurality of openings and a non-perforated area adjacent to the perforated area in the first direction. The non-perforated area is elongated in the second direction. The non-perforated area has a center portion and end portions formed on both sides of the center portion in the second direction. A width of the center portion is wider than the widths of the end portions.

According to the present invention, it is possible to increase the rigidity of the non-perforated area without increasing the difference between the tensions applied to both peripheries of the non-perforated area. Thus, the deformation of the non-perforated area can be restricted, and therefore the variation of the width of the end slit can be suppressed. When the color selection electrode is used as a mask in an exposure process for forming a phosphor screen, correct exposure can be performed, and therefore the edge of the effective screen area can be correctly formed. Further, the visual inspection of the end slit can be eliminated, with the result that the productivity and the yield rate of the color selection electrode assembly can be improved. Moreover, since the deformation of the non-perforated area is restricted, it is possible to prevent the metal stripes from vibrating and from being wrinkled, and thereby to improve the color purity.

### BRIEF DESCRIPTION OF THE DRAWINGS

In the attached drawings:

FIG. 1 is a side sectional view of a color cathode ray tube according to Embodiment 1 of the invention;

FIG. 2 is a plan view of a color selection electrode assembly of the color cathode ray tube according to Embodiment 1 of the invention;

FIG. 3A is a perspective view of a frame of the color selection electrode assembly according to Embodiment 1 of the invention;

FIG. 3B is a graph illustrating an example of the distribution of the tension applied to the color selection electrode by the frame shown in FIG. 3A;

FIG. 4A is a plan view illustrating the effect of the color cathode ray tube according to Embodiment 1 of the invention;

FIGS. 4B and 4C are plan views illustrating comparative examples as opposed to Embodiment 1 of the invention;

FIG. 5 is a plan view of a color selection electrode of a color cathode ray tube according to Embodiment 2 of the invention; and

FIG. 6 is a plan view of a color selection electrode of a color cathode ray tube according to Embodiment 3 of the invention.

### DETAILED DESCRIPTION OF THE INVENTION

The invention will now be described on the basis of the embodiments illustrated in the drawings.

Embodiment 1.

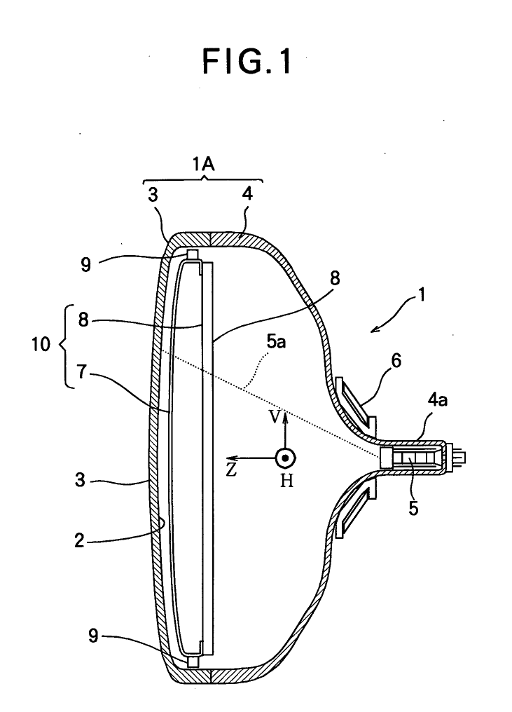

FIG. 1 is a side sectional view showing the structure of a color cathode ray tube according to Embodiment 1 of the invention. The cathode ray tube 1 according to Embodiment 1 includes a faceplate 3 on the inner surface of which a phosphor screen 2 is formed. A substantially funnel shaped portion referred to herein as funnel 4 is joined to the rear side of the faceplate 3. The faceplate 3 and the funnel 4 form a vacuum envelope 1A. The tube axis of the funnel 4 is referred to herein as Z-axis. The funnel 4 includes a neck 4a in which electron guns 5 are mounted. The electron guns 5 emit electron beams 5a toward the phosphor screen 2. The funnel 4 has a yoke mounting portion adjacent to the neck 4a. A deflection yoke 6 is mounted to the outer surface of the yoke mounting portion of the funnel 4. The deflection yoke 6 generates magnetic field for deflecting the electron beams 5a.

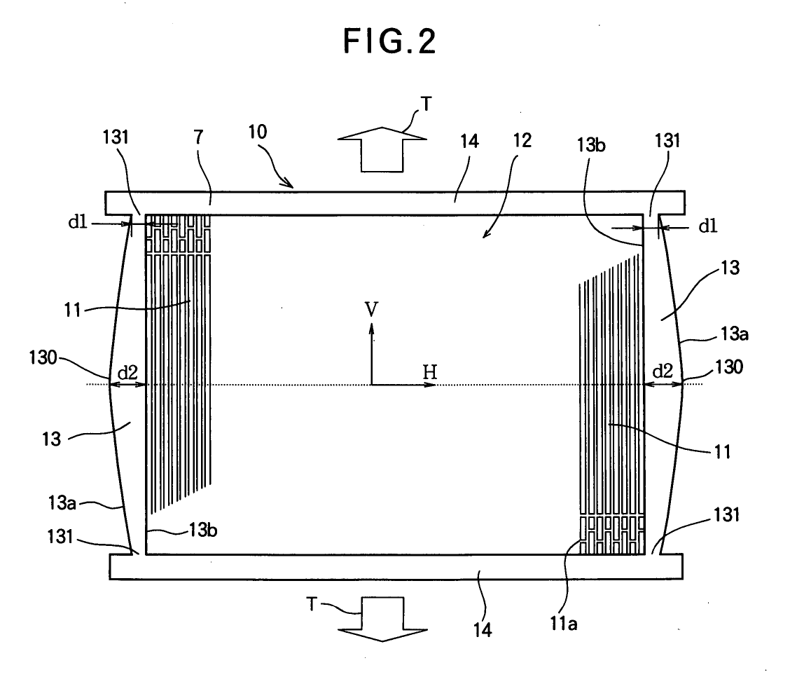

The phosphor screen 2 are formed by red, green and blue phosphors coated on the inner surface of the faceplate 3. A color selection electrode 7 is provided inside the faceplate 3. The color selection electrode 7 faces the phosphor screen 2, and is in parallel to the phosphor screen 2. The color selection electrode 7 is formed by selectively etching a thin metal plate to create a large number of slits 11 (FIG. 2) for the passage of the electron beams. The color selection electrode 7 has a color selection function that makes the three electron beams 5a emitted from the electron guns 5 incident on the red, green, and blue phosphors of the phosphor screen 2. A frame 8 for supporting the color selection electrode 7 is secured inside the faceplate 3. The frame 8 has resilient support members 9 that engage pins (not shown) formed on the inner surface of the faceplate 3. The color selection electrode 7 and the frame 8 together constitute a color selection electrode assembly 10.

FIG. 2 is a plan view of the color selection electrode assembly 10, as seen from the phosphor screen 2 side. The color selection electrode 7 has a rectangular shape. The direction parallel to the long sides of the color selection electrode 7 is defined as H-direction, i.e., a first direction. The direction parallel to the short sides of the color selection electrode 7 is defined as V-direction, i.e., a second direction. The H-direction and the V-direction are orthogonal with respect to Z-axis of the vacuum envelope 1A.

The color selection electrode 7 has a perforated area 12 of a substantially rectangular shape in which a plurality of slits (openings) 11 are formed. The slits 11 extend in the V-direction. The slits 11 are separated from each other by metal stripes. Each slit 11 has dummy bridges 11a extending from the metal stripes. The slits 11 can be replaced by openings having no dummy bridge. The color selection electrode 7 has welding areas 14 formed on both sides of the perforated area 12 in the V-direction. The welding areas 14 are to be welded to the frame 8 (FIG. 1).

The color selection electrode 7 has a pair of non-perforated areas 13 formed on both sides of the perforated area 12 in the H-direction. Each non-perforated area 13 is elongated in V-direction. Each non-perforated area 13 has a maximum width d2 at a center portion 130 in the V-direction, and a minimum width d1 at end portions 131 in the V-direction. The width d2 of the center portion 130 and the widths d1 of the end portions 131 satisfy the following relationship (1).

d2/d1≧1.5 (1)

A periphery of the non-perforated area 13 that faces the perforated area 12 is referred to as an inner periphery 13b. Another periphery opposite to the inner periphery 13b is referred to as an outer periphery 13a. The inner periphery 13b straightly extends in the V-direction, and the outer periphery 13a smoothly curves in the shape of a convex projecting in the direction away from the inner periphery 13b in the XY-plane. In each non-perforated area 13, the outer periphery 13a form a continuously curved line extending over the center portion 130 and the end portions 131.

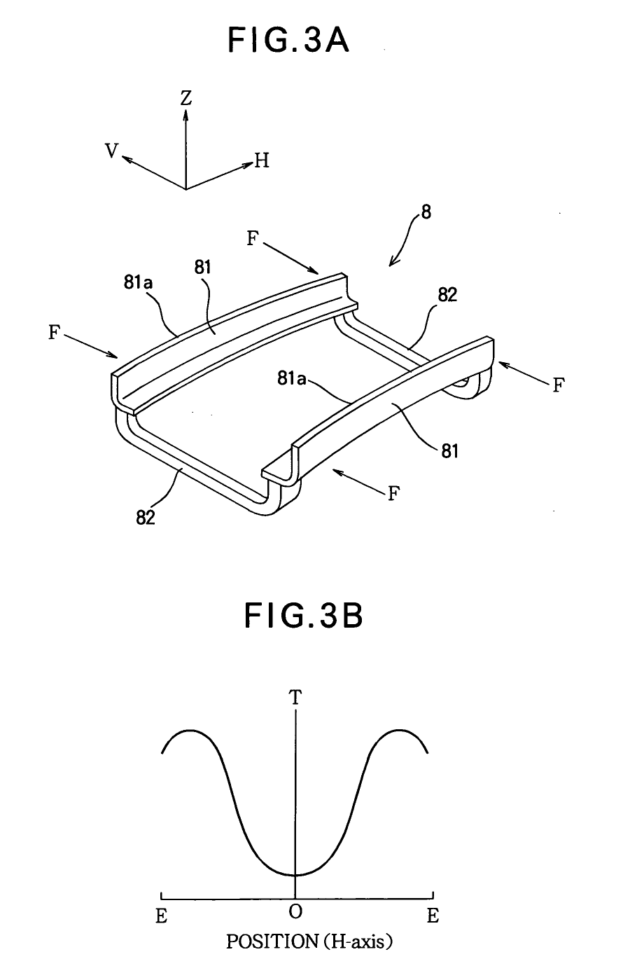

FIG. 3A is a perspective view of the frame 8 for supporting the color selection electrode 7. The frame 8 includes a pair of longitudinal members 81 elongated substantially in the H-direction, and a pair of transverse members 82 elongated substantially in the V-direction. The longitudinal members 81 have L-shaped cross sections, and have curved surfaces 81a facing the phosphor screen 2. The curved surfaces 81a (to be more specific, cylindrical surfaces) of the longitudinal members 81 have predetermined radius of curvature corresponding to the radius of curvature of the phosphor screen 2. The transverse members 82 join corresponding ends of the longitudinal members 81.

When the color selection electrode 7 is fixed to the frame 8, the longitudinal members 81 of the frame 8 are pressed in the direction toward each other so that the transverse members 82 resiliently deform. In this state, the welding areas 14 (FIG. 2) of the color selection electrode 7 are welded to the curved surfaces 81a of the longitudinal members 81 by means of electric resistance heating or laser beam. Then, the pressing of the frame 8 is stopped, so that the transverse members 82 return to their original shapes and urge the longitudinal members 81 away from each other by the resilient restoring force. As a result, the color selection electrode 7 is suspended by the frame 8 in such a manner that the frame 8 applies a tension T (FIG. 2) to the color selection electrode 7 in the V-direction.

FIG. 3B is a graph schematically illustrating the distribution of the tension T applied to the color selection electrode 7. In FIG. 3B, the lateral axis indicates the position along the H-direction. Along the lateral axis of FIG. 3B, “0” and “E” respectively denote the center and the ends of the color selection electrode 7 in the H-direction. The tension T applied to the color selection electrode 7 is the largest in the vicinity of the ends in the H-direction. Such a distribution of the tension T is effective in suppressing the vibration of the metal stripes in the end portions of the perforated area 12 in the H-direction, because the vibration of the metal stripes in the end portion of the perforated area 12 may easily result in a color shift.

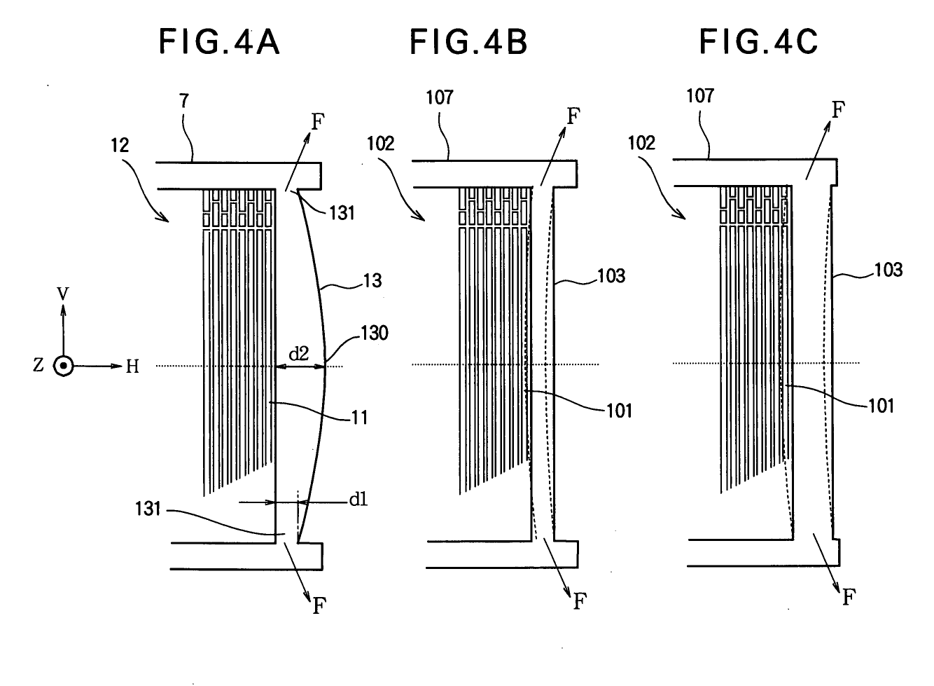

Next, the effects of the color cathode ray tube according to Embodiment 1 will be described. FIG. 4A is an enlarged plan view schematically showing the non-perforated area 13 according to Embodiment 1. FIGS. 4B and 4C are enlarged plan views showing comparative examples as opposed to Embodiment 1. FIG. 4B shows a color selecting electrode 107 having a band-shaped non-perforated area 103 that has a uniform width. FIG. 4C shows another color selecting electrode 107 having a band-shaped non-perforated area 103 that has a uniform width wider than that of FIG. 4B.

Because of the distribution of the tension T shown in FIG. 3B, the non-perforated area 103 tends to deform inwardly, as if an external force schematically shown by an arrow F acts on the non-perforated area 103. In the variation shown in FIG. 4B, the width of the non-perforated area 103 is uniformly narrow, and therefore the rigidity of the non-perforated area 103 is relatively low. Thus, the non-perforated area 103 may easily deform as shown by a dashed line, and therefore the width of an end slit 101 (i.e., a slit 101 closest to the end of the perforated area 102 in the H-direction) may decrease. Even by forming the extra slit in the non-perforated area 103, it is difficult to absorb the deformation of the non-perforated area 103.

In the variation shown in FIG. 4C, the width of the non-perforated area 103 is uniformly wide, and therefore the difference between the tensions applied to the outer and inner peripheries of the non-perforated area 103 increases. Thus, the non-perforated area 103 may easily deform, and therefore the width of the end slit 101 may decrease.

According to Embodiment 1, in contrast, the width d2 of the center portion 130 of the non-perforated area 13 is wider than the widths d1 of the end portions 131, and therefore it is possible to increase the rigidity of the non-perforated area 13 without increasing the difference between the tensions applied to the outer and inner peripheries of the non-perforated area 13. As a result, the deformation of the non-perforated area 13 can be suppressed, and therefore the deformation of an end slit 11 (i.e., the slit 11 closest to the end of the perforated area 12 in the H-direction) can be suppressed. Accordingly, the width of the end slit 11 can be kept constant. Further, since the deformation of the non-perforated area 13 is suppressed, a sufficient tension can be applied to the end of the perforated area 12 adjacent to the non-perforated area 13, and therefore it is possible to prevent the metal stripes from vibrating and from becoming wrinkled.

As described above, according to Embodiment 1, since the width d2 of the center portion 130 of the non-perforated area 13 is wider than the widths d1 of the end portions 131 of the non-perforated area 13, it is possible to suppress the deformation of the non-perforated area 13, and therefore the width of the end slit 11 can be kept constant.

Moreover, it is possible to prevent the metal stripes in the perforated area 12 from vibrating and from becoming wrinkled, and therefore the color purity can be improved.

In the process of forming the phosphor screen 2, the color selection electrode 7 is used as a mask for exposing the phosphor formed on the inner surface of the faceplate 3. As the width of the end slit 11 of the color selection electrode 7 is kept constant, it is possible to correctly form the phosphor screen.

Moreover, since the width of the end slit 11 can be kept constant, the visual inspection of the end slit 11 can be eliminated in the final inspection process of the color selection electrode assembly 10. Thus, the total process can be shortened, and therefore the productivity can be improved. Further, the yield rate can be enhanced.

Particularly, the width d2 of the center portion 130 and the widths d1 of the end portions 131 satisfy the above described relationship (1), and therefore it is ensured that the variation of the widths of the end slits 11 can be reduced and the color purity is improved.

Further, the outer periphery 13a of each non-perforated area 13 is in the form of a smoothly curved line, and therefore the structure in which the width d2 is wider than the width d1 can easily be accomplished.

Embodiment 2

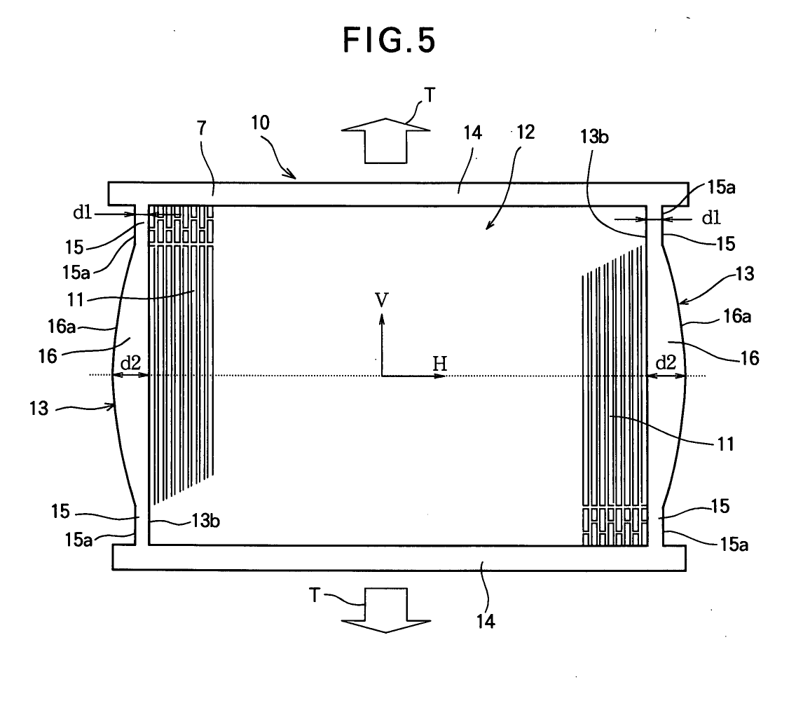

FIG. 5 is a plan view of a color selection electrode 7 of a color cathode ray tube according to Embodiment 2. The color selection electrode 7 of Embodiment 2 differs from the color selection electrode 7 of Embodiment 1 in the shape of the non-perforated area 13. In FIG. 5, structural elements common to the color selection electrode 7 of Embodiment 1 are designated by the same reference numerals.

In Embodiment 2, each non-perforated area 13 has a center portion 16 formed at the center in the V-direction, and end portions 15 formed on both sides of the center portion 16 in the V-direction. Each end portion 15 is band-shaped and has a uniform width d1. An outer periphery 15a of each end portion 15 straightly extends in the V-direction. The center portion 16 has an outer periphery 16a that curves in the shape of a convex projecting in the direction away from the perforated area 12. The center portion 16 has the maximum width d2 at the center position in the V-direction, and the minimum width d1 where the center portion 16 meets the end portions 15. An inner periphery 13b of each non-perforated area 13 straightly extends in the V-direction, as was described in Embodiment 1. The width d2 of the center portion 16 and the width d1 of the end portion 15 satisfy the relationship (1) described in Embodiment 1.

According to Embodiment 2, the width d2 of the center portion 16 of the non-perforated area 13 is wider than the width d1 of the end portions 15, and therefore it is possible to increase the rigidity of the non-perforated area 13 without increasing the difference between the tensions applied to the outer and inner peripheries of the non-perforated area 13.

Accordingly, as was described in Embodiment 1, it is possible to suppress the deformation of the non-perforated area 13, and therefore the width of the end slit 11 can be kept constant. Moreover, since the width of the end slit 11 can be kept constant, the visual inspection of the end slit 11 can be eliminated, and therefore the productivity and the yield rate of the color selection electrode assembly can be improved. Additionally, since the deformation of the non-perforated area 13 is suppressed, it is possible to prevent the metal stripes in the perforated area 12 from vibrating and from becoming wrinkled, and therefore the color purity can be improved.

Embodiment 3.

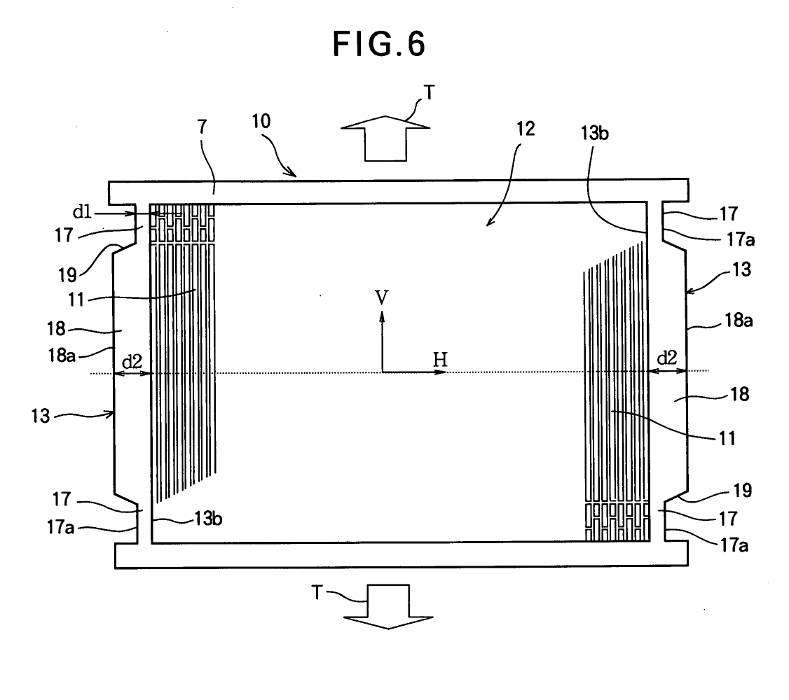

FIG. 6 is a plan view of a color selection electrode 7 of a color cathode ray tube according to Embodiment 3. The color selection electrode 7 of Embodiment 3 differs from the color selection electrode 7 of Embodiment 1 in the shape of the non-perforated area 13. In FIG. 6, structural elements common to the color selection electrode 7 of Embodiment 1 are designated by the same reference numerals.

In Embodiment 3, each non-perforated area 13 has a center portion 18 formed at the center in the V-direction, and end portions 17 formed on both sides of the center portion 18 in the V-direction. Each end portion 17 is band-shaped and has a uniform width d1. An outer periphery 17a of each end portion 17 straightly extends in the V-direction. The center portion 18 is band-shaped and has a uniform width d2 wider than the width d1. An outer periphery 18a of the center portion 18 straightly extends in the V-direction. Two step portions 19 are formed between the outer periphery 18a of the center portion 18 and the respective outer peripheries 17a of the end portions 17. Each step portion 19 is inclined with respect to the V-direction. An inner periphery 13b of each non-perforated area 13 straightly extends in the V-direction, as was described in Embodiment 1. The width d2 of the center portion 18 and the width d1 of the end portions 17 satisfy the relationship (1) described in Embodiment 1.

According to Embodiment 3, the width d2 of the center portion 18 of the non-perforated area 13 is wider than the width d1 of the end portions 17, and therefore it is possible to increase the rigidity of the non-perforated area 13 without increasing the difference between the tensions applied to the outer and inner peripheries of the non-perforated area 13.

Accordingly, as was described in Embodiment 1, it is possible to suppress the deformation of the non-perforated area 13, and therefore the width of the end slit 11 in the perforated area 12 can be kept constant. Moreover, since the width of the end slit 11 can be kept constant, the visual inspection of the end slit 11 can be eliminated, and therefore the productivity and the yield rate can be improved. Additionally, since the deformation of the non-perforated area 13 is suppressed, it is possible to prevent the metal stripes in the perforated area 12 from vibrating and from becoming wrinkled, and therefore the color purity can be improved.

In the above described Embodiments 1 through 3, the color selection electrode 7 has slit 11 having dummy bridges. However, the color selection electrode 7 can have other types of opening for the passage of the electron beams. For example, the color selection electrode 7 can be an aperture grille having stripe-shaped openings with no dummy bridges.

Those skilled in the art will recognize that further variations are possible within the scope of the invention, which is defined by the appended claims.

What is claimed is:

1. A color cathode ray tube comprising:
a vacuum envelope including a faceplate having a phosphor screen inside thereof, and a substantially funnel-shaped portion connected to said faceplate;
a rectangular color selection electrode provided in said faceplate in such a manner that said color selection electrode faces said phosphor screen, first and second directions substantially perpendicular to each other being defined on said color selection electrode; and
a frame fixed to said faceplate, said frame supporting said color selection electrode in such a manner that said frame applies a tension to said color selection electrode in said second direction,
wherein said color selection electrode includes a perforated area having a plurality of openings and a non-perforated area adjacent to said perforated area in said first direction, said non-perforated area is elongated in said second direction, said non-perforated area has a center portion and end portions formed on both sides of said center portion in said second direction, and a width of said center portion is wider than that of said end portions.

2. The color cathode ray tube of claim 1, wherein said width d1 of said end portion and said width d2 of said center portion satisfy the following relationship (1).
d2/d1≧1.5 (1)

3. The color cathode ray tube of claim 1, wherein said non-perforated area has an outer periphery, and said outer periphery at said center portion projects in the direction away from said perforated area, as seen from the direction perpendicular to said first and second directions.

4. The color cathode ray tube of claim 3, wherein said outer periphery forms a continuously curved line extending over said center portion and said end portions, as seen from the direction perpendicular to said first and second directions.

5. The color cathode ray tube of claim 3, wherein said outer periphery includes a curved line at said center portion and straight lines at said end portions, as seen from the direction perpendicular to said first and second directions.

6. The color cathode ray tube of claim 3, wherein said outer periphery includes a first straight line formed at said center portion, second straight lines formed at said end portions, and step portions between said first straight line and respective second straight line, as seen from the direction perpendicular to said first and second directions.

7. A color selection electrode assembly comprising:
a rectangular color selection electrode on which first and second directions substantially perpendicular to each other are defined; and
a frame supporting said color selection electrode in such a manner that said frame applies a tension to said color selection electrode in said second direction,
wherein said color selection electrode includes a perforated area having a plurality of openings and a non-perforated area adjacent to said perforated area in said first direction, said non-perforated area is elongated in said second direction, said non-perforated area has a center portion and end portions formed on both sides of said center portion in said second direction, and a width of said center portion is wider than that of said end portions.

8. The color selection electrode assembly of claim 7, wherein said width d1 of said end portion and said width d2 of said center portion satisfy the following relationship (1).
d2/d1≧1.5 (1)

9. The color selection electrode assembly of claim 7, wherein said non-perforated area has an outer periphery, and said outer periphery at said center portion projects in the direction away from said perforated area, as seen from the direction perpendicular to said first and second directions.

10. The color selection electrode assembly of claim 9, wherein said outer periphery forms a continuously curved line extending over said center portion and said end portions, as seen from the direction perpendicular to said first and second directions.

11. The color selection electrode assembly of claim 9, wherein said outer periphery includes a curved line at said center portion and straight lines at said end portions, as seen from the direction perpendicular to said first and second directions.

12. The color selection electrode assembly of claim 9, wherein said outer periphery includes a first straight line formed at said center portion, second straight lines formed at said end portions, and step portions between said first straight line and respective second straight line, as seen from the direction perpendicular to said first and second directions.
